(19) United States
(12) Patent Application Publication
(10) Pub. No.: US 2007/0289935 A1
(43) Pub. Date: Dec. 20, 2007

(54) Method for Tamper-Proof Crowning of Closed Containers with a Closure Means Comprising a Cap

(76) Inventors: Jacques Granger, Sainte-Terre (FR); Andre Luciani, Teche (FR)

Correspondence Address: DENNISON, SCHULTZ & MACDONALD, 1727 KING STREET, SUITE 105, ALEXANDRIA, VA, 22314, US

(21) Appl. No.: 11/628,765

(22) PCT Filed: Jul. 8, 2005
(86) PCT No.: PCT/FR05/01763

§ 371 Date: Jan. 18, 2007

(30) Foreign Application Priority Data
Jul. 12, 2004 (FR) 0407736

(51) Int. Cl. B67B 3/02; B65D 41/00

(52) U.S. Cl. 215/230; 53/488

(57) ABSTRACT

A method for crowning a container neck, such as a bottle, by securing or crimping a cap provided with a skirt on the neck, the neck including a glass ring with a lower shoulder, including the steps of a) crimping the cap to the neck, so as to form a swaged portion of the skirt; b) marking the swaged portion of the skirt with an etching device, to form an etching on the swaged portion based on an etching pattern. The visual mark reduces the mechanical properties of the swaged portion, so as to prevent any fraudulent attempt to uncrimp the cap from the neck or any recycling of the bottle.

### FIELD OF THE INVENTION

The invention relates to the field of tamper-proof means in the field of expensive alcoholic drinks, for example in the field of cognac bottles.

In particular, the invention relates to a method of capping bottles so as to prevent these bottles from being copied or re-used fraudulently.

### DESCRIPTION OF RELATED ART

French patent No. 2 658 166 is already known and discloses a tamperproof device for a cap surrounding a neck of a bottle, and wherein a sticker of rigid and brittle material is fixed both to the cap and to the neck by means of an adhesive that sets under UV radiation, such that the cap cannot be separated from the neck without destroying the sticker.

French patent No. 2 703 660 is also known that discloses a device guaranteeing the origin of a product using a thermoshrinkable sleeve covering a closing cap closing off a neck of a bottle and on which an inscription is engraved, for example using a laser, and is done overlapping the sleeve and the neck, such that the inscription composed of two complementary parts is destroyed when the sleeve is torn off during opening, without the possibility of bringing them together again later for fraudulent re-use of the bottle.

Finally, English patent No. 2 254 845 is known that discloses a method for closing a glass bottle neck using a closing cap covered with a transparent thermoshrinkable over cap. In this method, the thermoshrinkable over cap is sealed to the neck locally by an adhesive layer. A laser beam is applied facing the adhesive layer to focus the laser beam on the glass neck, so as to damage the glass surface such that the damage to the glass can only be seen after the over cap and the adhesive layer have been removed.

### PROBLEMS TO BE SOLVED

There are disadvantages with anti-fraud means known in the state of the art. Some of these means are difficult to use industrially because it is difficult to use them on a packaging line at high speed. Thus, in French patent No. 2 658 166, it is difficult to apply a sticker at high speed using an adhesive that is set under UV radiation.

Similarly, in English patent No. 2 254 845, it is difficult at high speed to apply an adhesive layer on the neck and then focus the laser beam on the glass neck so as to damage the glass surface invisibly.

Other tamper-proof means are not used or cannot be used for packaging of liquors or expensive alcohols in practice. Thus, expensive bottles of alcohol do not use a thermoshrinkable sleeve covering a closing cap as described in French patent No. 2 703 660, particularly because a traditional thermoshrinkable sleeve is not usually associated with up market over caps.

Finally, the effectiveness of some of these known means is uncertain.

### SUMMARY OF THE INVENTION

The method according to the invention is a method for capping the neck of a container, for example a bottle, by fixing or crimping a cap provided with a head and a skirt on the neck, the neck including a finish with a lower shoulder onto which the skirt can be fitted to the neck by crimping and formation of a necked part of the skirt under the shoulder delimiting a lower part of the skirt, the skirt including an upper non-necked part fixed to the head.

In this method:

a) the cap is crimped to the neck, so as to form the necked part of the skirt and to obtain a capped neck,

b) the necked part of the skirt is marked by an engraving device to make an engraving comprising a recessed engraving line or groove on the necked part over all or some of the thickness of the skirt following an engraving pattern, and a capped and marked neck is obtained with the engraving pattern, particularly so as to reduce the mechanical properties of the necked part, so that any attempt to fraudulently uncrimp the cap will cause visible damage or at least partial destruction of the necked part or the engraving.

The applicant has observed that this method could solve the problems that arise. By marking the cap so as to embrittle it once it is capped or crimped on the bottle neck, a twofold result is obtained, firstly because any marking may have a dissuasive effect towards potential frauders due to its visual effect if it has a somewhat complex structure, and secondly because marking according to the invention consists of making an incision in the skirt of the cap that locally weakens its mechanical properties, which makes it practically impossible to remove the cap and re-use it fraudulently.

Furthermore, firstly the invention does not need the addition of any extra material to the material making up the cap, and secondly the method according to the invention can be made during capping and typically at the standard capping speed so as to not reduce the capping productivity in any way.

### BRIEF DESCRIPTION OF THE DRAWINGS

FIG. 1a shows a side view of a neck (4) with an axis (40) including a finish (41) provided with an upper threaded part (43) and a lower shoulder (42), and a closing cap (1, 1′) placed above the neck, before capping, with a head (3) and a skirt (2) including an easy first opening means (23) provided with a line of weakness.

FIG. 1b shows a side view of the capped neck (6) formed with a crimped or capped cap (10) after the neck (4) has been capped with the cap (1, 1′) in FIG. 1a.

FIG. 1c is an enlargement of a partial sectional view of part of FIG. 1b surrounded by a circle in dashed lines that shows the necking (20, 200) of the skirt (2) of the crimped cap (10) under the lower shoulder (42) of the finish (41) of the neck (4).

FIGS. 2a to 2d show marking of a cap of a neck (6) capped with the cap according to FIG. 1b.

FIG. 2a is a diagrammatic view of an engraving device (7) using a plurality of laser beams (70) and mirrors (71) in order to engrave a capped neck (6).

FIGS. 2b to 2d show capped and marked necks (6′) provided with a marked cap (11) according to an engraving pattern (52) and obtained from the crimped cap (10).

FIG. 2b shows the case wherein engraving (5) is formed in the necked part (20) of the skirt (2), forming the word “Cognac” in print type as an engraving pattern (52).

FIG. 2c shows the case wherein the engraving (5) is formed in the necked part (20) including the part (200) with slope >0°, in curved handwriting as the engraving pattern (52),

FIG. 2d shows the case wherein the engraving (5) passes through the part (200) with slope >0° and extends into the upper part (22) of the skirt (2).

FIG. 3, similar to FIG. 2a, shows the case of a laser engraving device (7) that is a laser engraving device (7′) used to do the engraving (5) using a mask (73), illumination by a single laser light source, the device being surrounded by an external protective wall (74).

FIG. 4a is similar to FIG. 1a, the cap (1) being an over cap (1′) , the neck (4) not including a threaded part being closed off by a cork (9) shown in dashed lines.

FIG. 4b is similar to FIG. 1b, and is a side view of the capped neck (6′) provided with an engraved cap (11) formed by marking of the cap (10) after the cap (1, 1′) has been fitted on the neck (4) in FIG. 4a.

FIG. 4c shows the case wherein the engraving pattern (52) represents a curved writing line with letters (53), the loops of the letters (53) including loops with material bridges (530) or areas not marked or engraved, so as to fix the inside of the loops to the outside of the loops.

FIGS. 5a to 5c show a variant of the over cap (1″).

FIG. 5a corresponds to FIG. 4a, the cork being a shouldered stopper (9′).

FIG. 5b is similar to FIG. 1b and shows the capped neck (6).

FIG. 5c is similar to FIG. 4b.

FIGS. 6a to 6c show a variant of a closing cap

FIG. 6a is similar to FIG. 1a.

FIG. 6b shows a capped neck (6) seen in a side view with a crimped cap (10′) shown in an axial side view section. In this crimped cap (10′), the necked part (20) forms an annular necked rib (201), the remainder of the lower part of the skirt not being forced into contact with the neck and necked.

FIG. 6c is similar to FIG. 5c.

FIG. 7a is a diagrammatic view of the engraving (5) including two parts (54) and (54′) symmetric about the axis (40) of the neck in the form of two engraved helical lines.

FIG. 7b is a partial view of an axial section through the capped neck (6′) provided with an engraved cap (11) provided with windows (540) and (540′) facing each other, arranged symmetrically about the axis (40) so as to enable a measurement of the attenuation of a light beam (541).

FIG. 7c is a diagram that shows the case wherein there is a variation in the depth H of the engraving as a function of the angle θ between 0° and 180° in FIG. 7a, while FIG. 7d that is similar to FIG. 7c corresponds to the case wherein the engraving depth H remains constant.

FIG. 7f is similar to FIGS. 7c and 7d shows the case wherein the engraving (5) includes the entire pattern (52) forming the first engraving (50) for the skirt (2) and only a small part of the pattern (52) for the neck (4), for the second engraving (51).

FIG. 8a shows a side view that is similar to FIG. 2d wherein the engraving device is a mechanical engraving device (8) including a knurl (80) free to rotate about an axis (81) and having an engraving in “negative” relief (82), that can reproduce the engraving on the capped neck (6) by radial pressure.

FIG. 8b is similar to FIGS. 2b and 8a, and shows the case wherein the engraving pattern (52) is a geometric pattern (52′) formed by a plurality of parallel incisions (520).

### DETAILED DESCRIPTION OF THE INVENTION

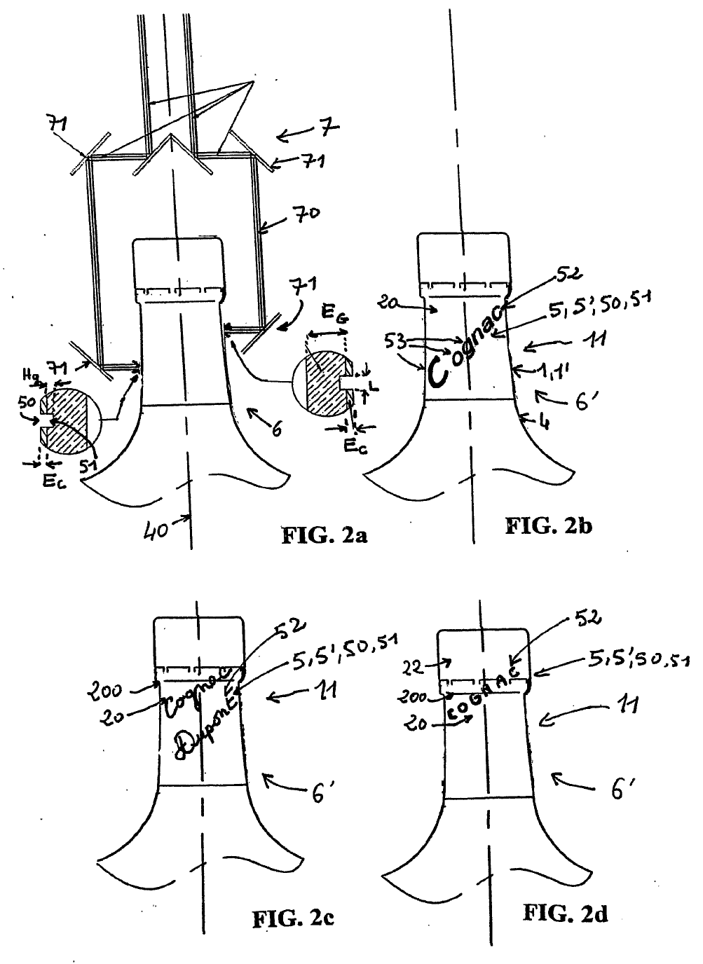

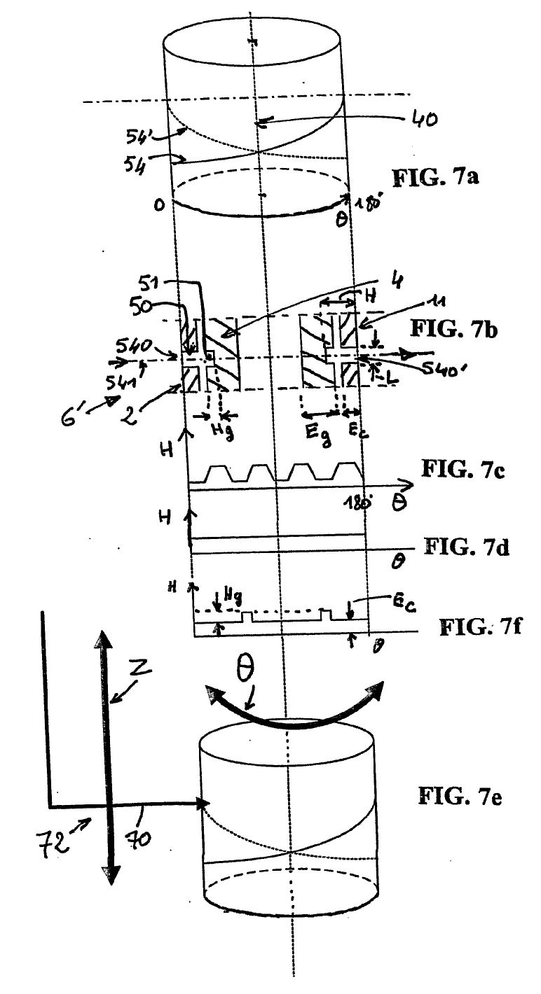

According to the invention, the engraving (5) may include a first engraving (50) passing through the skirt over its entire thickness Ec, like an incision as shown in the FIGS. 2a and 7b.

The engraving (5) may include a second engraving (51) including a surface engraving of the neck (4) typically made of glass, like a partial incision into the neck as shown also in FIGS. 2a and 7b.

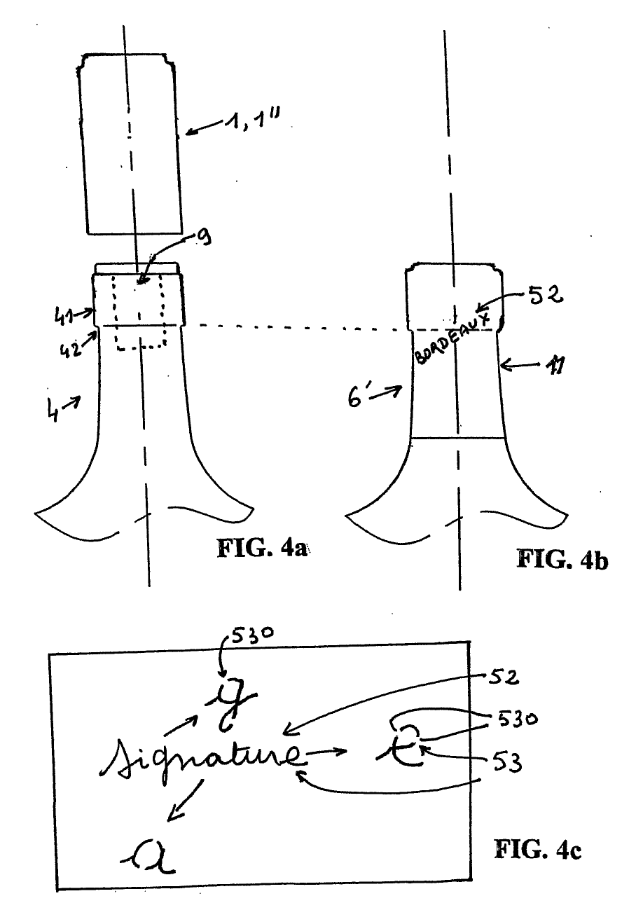

As shown for example in FIGS. 2b to 2d and in FIG. 4c, the engraving pattern (52) may form a write line representing a sequence of letters (53) in print type or in cursive script, every loop of a letter (53) including at least one material bridge (530) so that the inner part of the loop remains fixed to the outer part of the the loop.

The write line may be a continuous line (54) typically formed by cursive script.

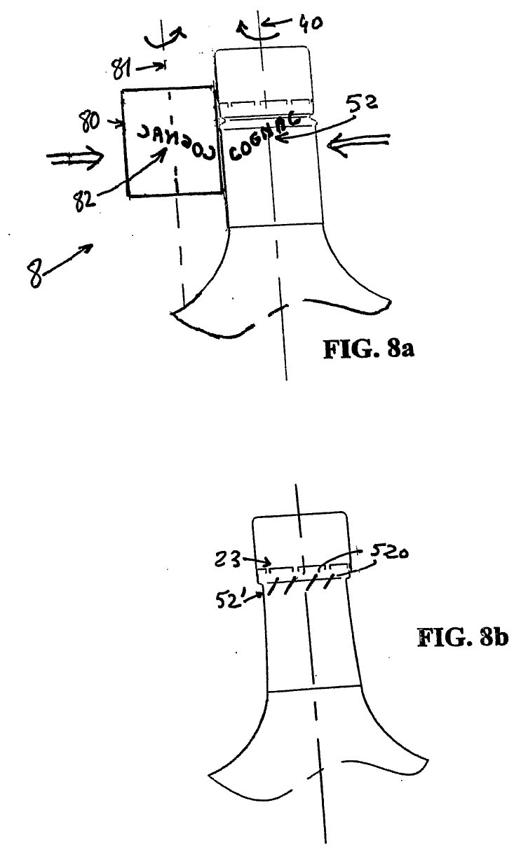

But the engraving pattern (52) may also represent geometric or decorative elements other than letters, as long as these elements weaken the crimped part of the skirt of the cap as shown in FIG. 8b.

As shown in FIGS. 7a and 7b, the engraving (5) may include at least two parts (54, 54′, 540, 540′) symmetric about the axial direction (40) of the neck (4), so as to enable the passage of a light beam (541) passing through the neck from one side to the other perpendicular to the axial direction (40), so as particularly to be able to measure the absorption ratio of the light beam passing through the neck.

Therefore the engraving (5) can also be used to record additional measurable characteristics in the neck in order to verify if a capped and marked neck (6′) is conform with an authentic neck (6′) as shown in FIG. 7c and 7f.

According to the invention, the line thickness L of the engraving (5) or the engraving line (5′) may vary from 0.2 mm to 2 mm.

As shown in FIG. 7b, the depth Hg of the second engraving or engraving (51) of the surface of the neck (4) may vary from 0.1 mm to 1 mm, with Hg/Eg typically varies from 0.01 to 0.3, where Eg is the radial thickness of the neck (5).

The engraving (5) or the engraving line (5′) may have a line width L variable from one point to another on the line, as a function of an arc length of the point.

As shown in FIG. 7c or 7f, the line depth H of the engraving (5) or the engraving line (5′) may be variable from one point to another on the line, as a function of an arc length of the point, or as a function of its angular coordinate θ.

The engraving, particularly concerning the second engraving (51) of the neck, can therefore be defined by a plurality of parameters, which will make fraudulent reproduction of such engraving extremely complex.

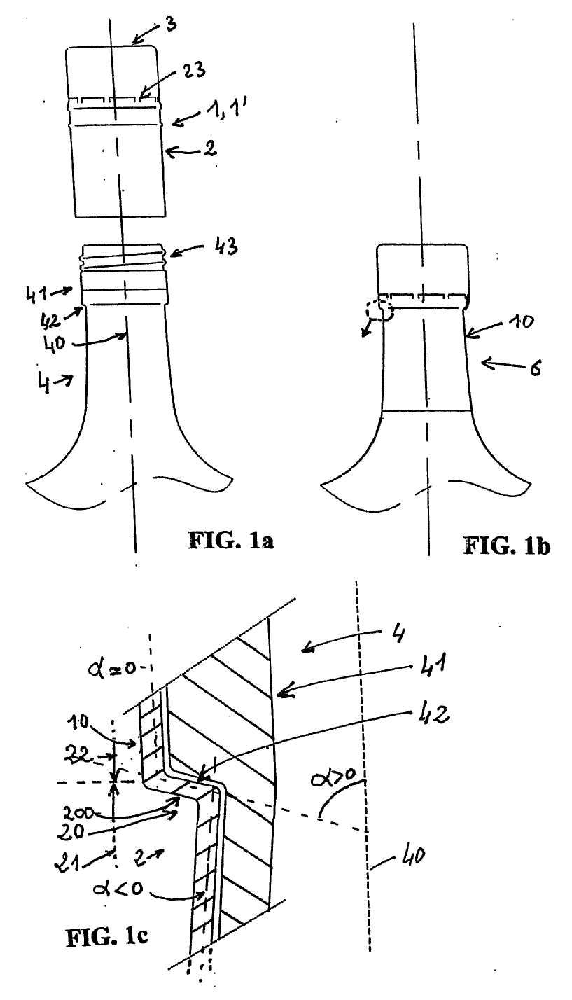

According to the invention, the necked part (20) including a part (200) with slope α>0° with a maximum deformation as shown in FIG. 1c, the engraving (5) or the engraving line (5′) can extend over or pass through the part (200) with slope α>0° as shown in FIGS. 2c, 2d, 4b, 5c and 6c.

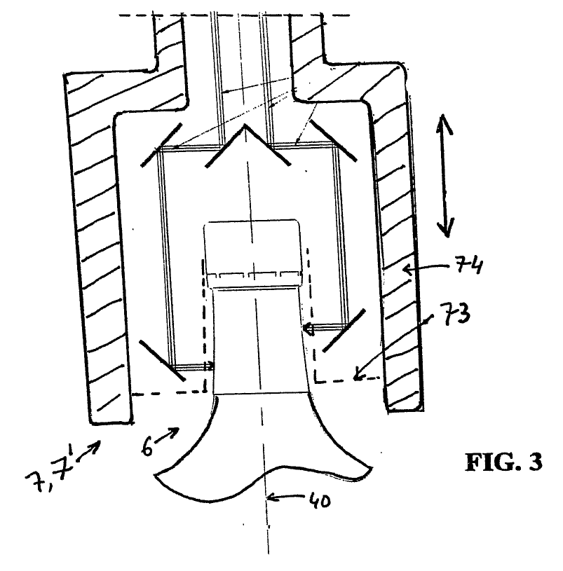

As shown in FIGS. 2a and 3, the engraving device may be an engraving device (7) using a laser beam (70).

The engraving device (7) may include an electronic mask or a perforated mask (73) to allow the laser beam (70) to pass through it in order to form the engraving (5) or the engraving line (5′), typically at high speed, i.e. the capping speed as shown in FIG. 3.

As shown in FIG. 7e, the device may include a means (72) of slaving the ordinate z of the laser beam (70) as a function of the rotation angle θ of the neck (4) of the container or the bottle to be capped.

As shown in FIG. 8a, the engraving device may be a mechanical engraving device (8), typically including en engraved rotating knurl (80) applied with radial pressure in contact with the necked part (20) of the skirt (2).

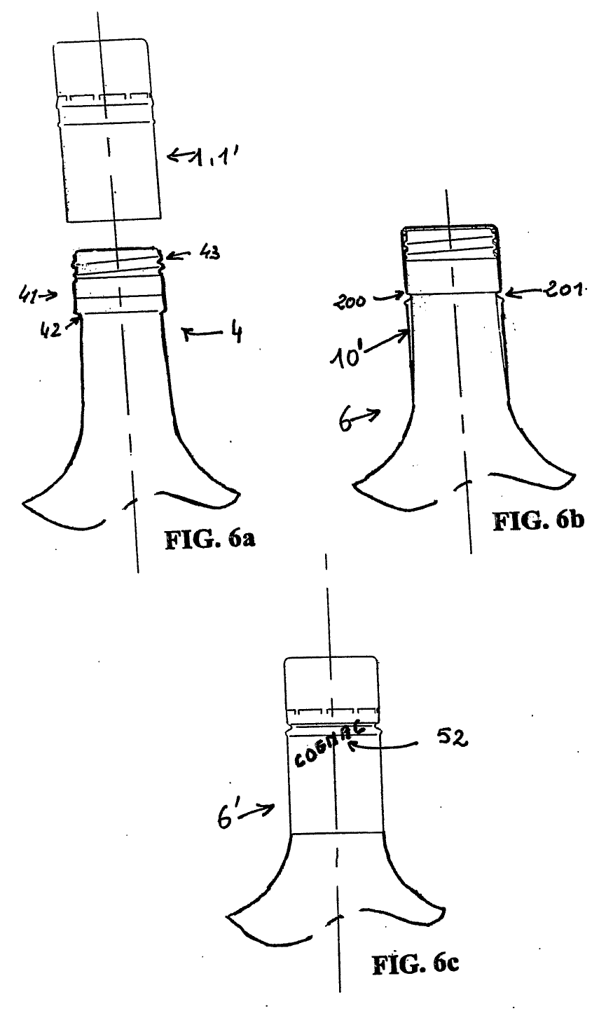

According to the invention, the cap (1) may be a closing cap (1′) as shown in FIGS. 1a and 6a.

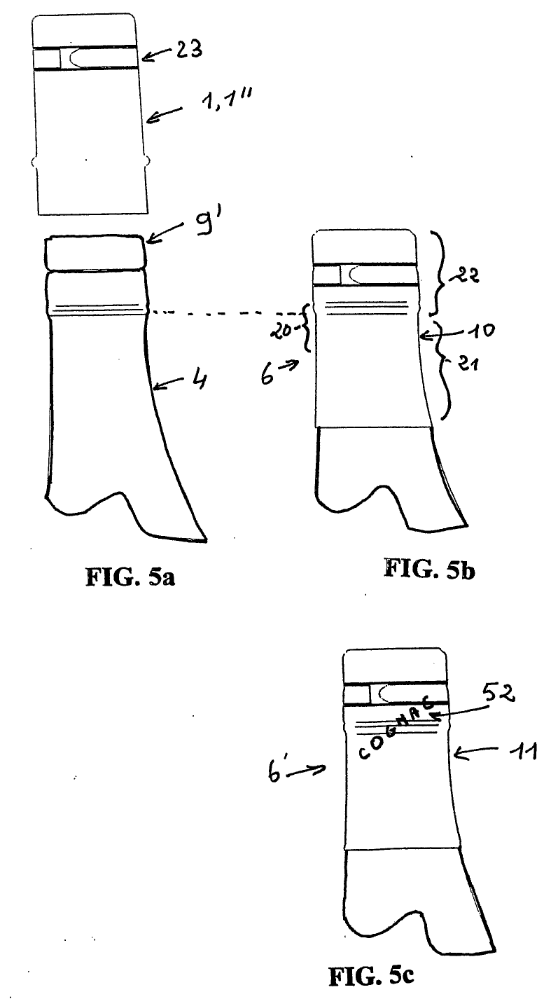

The cap (1) may be an over cap (1″) associated with a closing means, typically a cap (9, 9′) like that shown in FIGS. 4a and 5a.

The cap (1, 1′, 1″) may be a metallic or metalloplastic cap that can be crimped.

The cap (1, 1′, 1″) may be a cap made of thermoshrinkable plastic material.

Typically, the skirt (2) of the cap (1, 1′, 1″) may include a first easy opening means (23) located on the upper part (22) of the skirt (2), so that it is located above the necked part (20, 200) as shown in FIGS. 1a, 5a, 6a.

In general, the engraving (5) is entirely below the first opening means, such that the part of the cap located above the first opening means (23), and particularly the head (3) of the cap, can be removed without damaging or modifying the engraving (5).

Another purpose of the invention consists of a container, typically a bottle provided with a neck (4) on which a cap (1, 1′, 1″) is fitted using the method according to the invention. In this container, the neck (4) may be capped with a cap (1, 1′, 1″) using a necked part of the cap (20), the necked part (20) and possibly the neck facing the necked part (20) being marked with an engraving pattern (52) cutting into the thickness of the crimped cap (10) and possibly the neck (4) over a part of its thickness, such that any opening of the container will cause destruction or visible alteration to the cap, or such that it becomes difficult for a frauder to reuse the container, or such reuse can be identified by the original manufacturer.

### EXAMPLE EMBODIMENTS

All figures are related to the invention and describe example embodiments.

Concerning the initial caps (1), the invention was applied to the applicant's traditional closing caps (1, 1′) as shown in FIGS. 1b, 2a to 2d, and 6a to 6c.

These closing caps (1′) were made either from pewter or aluminium.

The invention was also applied to over caps (1″).

These over caps were made either of pewter, aluminium or a metalloplastic material.

Closing caps (1′) and over caps (1′) made of a plastic thermoshrinkable material were also used as caps (1).

The closing caps (1′) include an inner insert with a threaded skirt.

These caps were assembled to a bottle neck (4) to obtain capped necks (6).

The closing caps (1′) and some over caps (1″) were screwed onto Cognac bottle necks (4′) with a thread (43) and were then crimped in the case of metallic caps (1′).

The over caps (1′) were placed on necks (4) of Bordeaux bottles and were then crimped in the case of metallic caps (1′) or heat shrunk in the case of thermoshrinkable caps (1′).

Different engraving devices were used to mark and engrave these necks (6) and thus obtain capped and marked necks (6′) according to the invention:

a laser beam engraving device (7) was used in different embodiments as shown in FIGS. 2a, 3 and 7e. A pulsed laser or a non-pulsed laser was used. A CO2 power laser was used with a wavelength of 10.6 μm, preferably associated with a helium-neon laser so as to make the laser beam visible for safety reasons,

a mechanical engraving device (7′) was also used as shown diagrammatically in FIG. 8. In this case, only the skirt of the cap was engraved with a “V” shaped incision.

In the tests that were carried out, engraving lines (5′) were formed representing engraving patterns (52) in the form of letters of the alphabet (53) as shown in FIGS. 2b to 2d, 4b, 4c, 5c, 6c and 8a. The engraving pattern (52) used consisted of the word “cognac” or “bordeaux”. However, as shown in FIG. 8b, the engraving pattern (52) used was a geometric pattern (52') formed by a plurality of parallel incisions (520) cutting the steeply sloping part (200) of the necked part (20) from one side to the other, so as to weaken the cap in this part without damaging it visually.

The width L of the engraving is constant and equal to 1 mm in the case of a laser engraving, and its depth H is equal to the thickness of the skirt of the cap Ec, plus the depth Hg of the engraving of the glass in the neck, where Hg is equal to 0.2 mm.

The thickness of the skirt Ec is equal to:

0.23 mm in the case of metallic closing caps (1′)

0.10 mm in the case of metallic over caps (1″)

0.3 mm in the case of thermoshrinkable caps (1′) made of a plastic material

0.2 mm in the case of thermoshrinkable over caps made of a plastic material.

A “composite” engraving was also formed including the first engraving (50) on the skirt (2) and some engraving points on the neck as shown in FIG. 7f.

In this case, the entire pattern (52) is formed on the necked part (20) of the skirt (2), while only a small part of the pattern (52) is formed on the neck (4).

In this case, it may be advantageous if the part of the pattern (52) formed on the neck forms windows arranged symmetrically about the axis (40) of the neck, as shown in FIG. 7b, so as to form a complementary fraud detection means. This can also be used to detect a tracer concealed in the glass, to determine whether the container is an original container.

Results Obtained:

It was seen that all attempts to separate the cap from the neck and to reuse it afterwards were unsuccessful.

Despite special efforts and special care, it was impossible to separate caps without visibly deteriorating them.

Furthermore, when the bottle neck was marked by a laser beam, it becomes more difficult to reuse the bottle, assuming that it is possible to reproduce a cap engraved according to the invention. In this case, the frauder would not be able to crimp the cap onto the neck without visibly altering it or destroying it so that he would be obliged to cap the neck with an unengraved cap, then he should make the first engraving (50) without touching the second engraving (51), while assuring that the first and second engravings are facing each other.

These conditions are at least very difficult if not impossible to perform, even at a craftsman scale.

### ADVANTAGES OF THE INVENTION

Firstly, the invention makes it very difficult to make a fraud by recycling authentic caps, by recycling authentic containers, by copying caps or by copying authentic containers.

Furthermore, in assuming that fraudulent fabrication of capped bottles resembling original capped bottles is possible, the invention provides means of identifying original products, particularly original containers.

Finally, compared with traditional capped bottles, the invention does not introduce any excess material cost and it does not reduce the capping speed.

### LIST OF MARKS

Cap . . . 1
Closing cap . . . 1′
Over cap . . . 1″
Cap crimped or fitted on 4 . . . 10, 10′
Cap crimped or fitted and engraved . . . 11
Skirt of 1 . . . 2

Necked part of 2 . . . 20

Part of 20 with slope α>0 . . . 200

Annular groove on necked part . . . 201

Lower part of 2 . . . 21

Upper part of 2 . . . 22

Easy first opening means . . . 23
Head of 1 . . . 3
Bottle neck . . . 4

Axis of 4 . . . 40

Finish of 4 . . . 41

Lower shoulder of 40 . . . 42

Threading . . . 43
Engraving formed on 20 . . . 5
Engraving line . . . 5′
First engraving of 2 . . . 50
Second engraving of 4 . . . 51
Engraving pattern . . . 52, 52′

Incision . . . 520
Letters of 52 . . . 53

Material bridges . . . 530
Parts of 5 symmetric with respect to 60 . . . 54, 54′

Measurement windows . . . 540,540′

Measurement light beam . . . 541
Capped neck . . . 6
Marked capped neck . . . 6′

Axial direction—axis of neck . . . 60
Laser engraving device . . . 7

Laser beam . . . 70

Reflecting mirrors of 71 . . . 71

Slaving means . . . 72

Mask . . . 73

External wall . . . 74
Mechanical engraving device . . . 8

Knurl . . . 80

Rotation axis of 80 . . . 81

Engraving in relief . . . 82
Closure means . . . 9

1. Method for capping a neck of a container with an axial direction, for example a bottle, by fixing or crimping a cap provided with a head and a skirt on the neck, the neck including a finish with a lower shoulder with which the skirt can be fixed to the neck by crimping the skirt and forming under the shoulder a necked part that delimites a lower part and an upper part of the skirt, the skirt thus comprising a non-necked upper part fixed to the head, the method comprising following steps:
a) crimping the cap to the neck, so as to form the necked part of the skirt and to obtain a capped neck,
b) marking the necked part of the skirt using an engraving device to make an engraving, wherein said engraving comprises:
b1) a recessed engraving line or groove on the necked part over all or part of the thickness of the skirt following an engraving pattern, so as to obtain a capped and marked neck with the engraving pattern, particularly so as to reduce the mechanical properties of the necked part, so that any attempt to fraudulently uncrimp the cap from the capped and marked neck will cause visible damage or at least partial destruction of the necked part or the engraving of the cap,
b2) a second engraving comprising a surface engraving of the neck, said neck being typically made of glass.

2. Method according to claim 1, wherein the engraving comprises a first engraving passing through the skirt over its entire thickness.

3. Method according to claim 1, wherein the engraving pattern forms a write line representing a sequence of letters in print type or in cursive script, every loop of a letter including at least one material bridge so that the inner part of the loop remains fixed to the outer part of the loop.

4. Method according to claim 3, wherein the write line is a continuous line typically formed by a cursive script.

5. Method according to claim 2, wherein the engraving comprises at least two parts symmetric about the axial direction of the neck so as to enable passage of a light beam passing through the neck from one side to the other perpendicular to the axial direction, in particular so as to measure the absorption ratio of the light beam passing through the neck.

6. Method according to claim 1, wherein the line thickness of the engraving or the engraving line varies from 0.2 mm to 2 mm.

7. Method according to claim 1, wherein the depth of the second engraving or surface engraving of the neck varies from 0.1 mm to 1 mm, with Hg/Eg typically varying from 0.01 to 0.3, where Eg is the radial thickness of the neck and Hg is the depth of the second engraving or surface engraving of the neck.

8. Method according to claim 1, wherein the engraving or the engraving line has a line width variable from one point to another on the line, as a function of an arc length of the point.

9. Method according to claim 1, wherein the line depth of the engraving or the engraving line is variable from one point to another on the line, as a function of an arc length of the point, or as a function of its angular coordinate θ.

10. Method according to claim 1, wherein the necked part including a part with slope α>0° with a maximum deformation, the engraving or the engraving line extends over or passes through the part with slope α>0°.

11. Method according to claim 1, wherein the engraving device is an engraving device using a laser beam.

12. Method according to claim 11, wherein the engraving device includes an electronic mask or a perforated mask to allow the laser beam to pass through it in order to form the engraving or the engraving line, typically at high speed, i.e. the capping speed.

13. Method according to claim 11, wherein the device includes a means of slaving the ordinate z of the laser beam as a function of the rotation angle θ of the neck of the container or the bottle to be capped.

14. Method according to claim 1, wherein the engraving device is a mechanical engraving device, typically including en engraved rotating knurl applied with radial pressure in contact with the necked part of the skirt.

15. Method according to claim 1, wherein the cap is a closing cap.

16. Method according to claim 1, wherein the cap is an over cap associated with a closure means, typically a cork.

17. Method according to claim 1, wherein the cap is a metallic or metalloplastic cap that can be crimped.

18. Method according to claim 1, wherein the cap is made of a thermoshrinkable plastic material.

19. Method according to claim 1, wherein the skirt of the cap includes a first easy opening means located on the upper part of the skirt, so that it is located above the necked part.

20. Container, typically a bottle, provided with a neck on which a cap is fitted using a necked part of the cap, the necked part and possibly the neck facing the necked part being marked with an engraving pattern cutting into the thickness of the cap and possibly the neck over a part of its thickness, such that any opening of the container will cause destruction or visible alteration to the cap, or such that it becomes difficult for a frauder to reuse the container, or such reuse can be identified by the original manufacturer.

21. Container, typically a bottle, provided with a neck capped with a cap using the method as claimed in claim 1.

22. Container according to claim 21, wherein the neck on which a cap is fitted using a necked part of the cap, the necked part and possibly the neck facing the necked part being marked with an engraving pattern cutting into the thickness of the cap and possibly the neck over a part of its thickness, such that any opening of the container will cause destruction or visible alteration to the cap, or such that it becomes difficult for a frauder to reuse the container, or such that reuse can be identified by the original manufacturer.
